(19) United States
(12) Patent Application Publication
(10) Pub. No.: US 2026/0216791 A1
(43) Pub. Date: Jul. 30, 2026

(54) BINDER-JETTING ADDITIVE MANUFACTURING SYSTEM

(71) Applicant: SAFRAN, PARIS (FR)

(72) Inventors: Karine NGUYEN, MOISSY-CRAMAYEL (FR); Pierre Jean SALLOT, MOISSY-CRAMAYEL (FR); Gautier HUSER, MOISSY-CRAMAYEL (FR)

(21) Appl. No.: 19/145,055

(22) PCT Filed: Dec. 22, 2023
(86) PCT No.: PCT/FR2023/052116

§ 371 Date: Jul. 1, 2025

(30) Foreign Application Priority Data
Jan. 11, 2023 (FR) FR2300289

(51) Int. Cl. B22F 12/30; B22F 10/14; B28B 1/00; B33Y 10/00; B33Y 30/00

(52) U.S. Cl. CPC B22F 12/30; B22F 10/14; B28B 1/001; B33Y 10/00; B33Y 30/00; B22F 2998/10

(57) ABSTRACT

A system for powder bed fusion additive manufacturing includes build chamber extending along a vertical axis and a removable container capable of being inserted into the build chamber in a manufacturing configuration and of being removed from the build chamber in a depowdering configuration. The removable container includes a side wall extending along the vertical axis and a bottom wall capable of movement along the vertical axis inside the side wall and which includes a perforated first wall comprising first orifices configured to be closed off in the manufacturing configuration and unblocked in the depowdering configuration.

### TECHNICAL FIELD

The present disclosure relates to the field of the additive manufacturing of parts. More specifically, the present document relates to a system and a method of additive manufacturing by powder bed fusion using a metal or ceramic powder, in particular for the aeronautical field, for example for the manufacture of turbine engine parts.

### PRIOR ART

It is known to use additive manufacturing processes based on powder bed fusion and on spraying with binder, commonly referred to as binder jetting, because these techniques advantageously allow three-dimensional parts of complex shape to be produced easily and quickly. These techniques are used in the aeronautical field in particular, for the production of metal parts of complex shape.

FIGS. 1A and 1B schematically illustrate a partial section view of a machine for binder jetting additive manufacturing, each representing one of two stages in the manufacturing of parts 6. In particular, the binder jetting additive manufacturing process consists successively of a step of depositing a powder layer 7 on a build plate 5, followed by a step of selectively spraying a liquid binder through a nozzle in order to solidify (by binder polymerization) a section of part 6 in the build plane. The build plane is substantially perpendicular to a vertical axis Z corresponding to the manufacturing direction. Powder layer 7 is spread transversely over build plate 5 by a scraper. Build plate 5 is then moved downward in translation along vertical axis Z within a build vat 4, to allow the deposition of the next powder layer. The above steps are successively repeated, layer after layer, to form at least one part 6 called a “green part”.

A “depowdering” step is conventionally carried out, to remove the unsolidified powder and expose the green parts. A debinding step is then carried out, to eliminate most of the binder from the green parts. At the end of this step, “brown parts” are obtained, which contain a network of interconnected porosities. This network of porosities is the reason for the fragility of the brown parts and for their lack of mechanical strength, rendering the handling of brown parts a delicate process. The brown parts are then heat-treated to remove binder residue and ensure cohesion of the parts by creating strong bonds between particles through material diffusion, leading to the elimination of porosities and material densification, in a sintering process that results in a sintered part.

It is understood that it is only after the sintering step that the parts acquire good mechanical strength, and that the green and brown parts are generally very fragile. The depowdering step is one of the critical steps and may cause breakage or deformation of the green parts.

More specifically, a preliminary step called “unloading” is traditionally performed to remove the volume of powder, including the green parts, from the build vat. This step can potentially result in breakage of the green parts due to the forces exerted by the powder on the green parts. Furthermore, this step may involve prolonged exposure of additive manufacturing machine users to suspended loose powders posing a high HSE risk.

In addition, a step is then carried out to remove excess powder from the green parts, for example by techniques using air flow or mechanical movements. These techniques may also damage the green parts.

The present document aims to address at least some of the problems mentioned above, by proposing a system for binder jetting additive manufacturing and an associated method which allow improving the depowdering of manufactured parts and thus reducing the risk of damage to the green parts.

### SUMMARY

A system for binder jetting additive manufacturing is provided, comprising a build chamber extending along a vertical axis and a removable container capable of being inserted into the build chamber in a manufacturing configuration and of being removed from the build chamber in a depowdering configuration. The removable container comprises a side wall extending along the vertical axis. In addition, the removable container comprises a bottom wall which is capable of movement along the vertical axis inside the side wall and which comprises a perforated first wall comprising first orifices configured to be closed off in the manufacturing configuration and unblocked in the depowdering configuration. “Closed off” is understood to mean that a flow of powder cannot pass through the orifices, and “unblocked” is understood to mean that a flow of powder can freely pass through the orifices. In other words, in the manufacturing configuration, the removable container is advantageously housed in the build chamber, and the first orifices of the perforated first wall are closed off. The bottom wall is driven downwards in translation along the vertical axis during manufacturing. In the depowdering configuration, the removable container can then be moved out of the build chamber, for example into a depowdering zone, and the first orifices of the perforated first wall can be unblocked to allow powder to flow through the first orifices. The perforated first wall performs a sieve function by retaining the parts and allowing the powder to flow out of the removable container by gravity.

Such a system makes it possible to facilitate and improve the depowdering of green parts after the said parts have been produced by successive deposition of layers of powder and binder jetting. Indeed, the removable container allows easily removing from the build chamber, and moving to a depowdering zone, a block formed of powder in which at least one green part is embedded. Such a removable container may also easily be utilized with an existing machine for binder jetting additive manufacturing. In the depowdering zone, unblocking the first orifices of the perforated first wall facilitates the discharge of powder through the bottom wall, while reducing the risks of deformation or even breakage of the at least one green part. The removable container enables the transfer of green parts, even those of smaller dimensions and/or lighter weight. In addition, the removable container is advantageously compatible with depowdering techniques that involve immersion in a liquid bath, blowing air, or mechanical vibrations. In addition, the removable container according to the present disclosure allows limiting a user's exposure to the powder, for example when handling the system for binder jetting additive manufacturing.

The features set forth in the following paragraphs may optionally be implemented, independently of one another or in combination with one another.

A maximum dimension of the first orifices of the perforated first wall is preferably less than, preferably less than 50% of, a minimum dimension of said at least one part to be manufactured in the removable container.

The first orifices of the perforated first wall may have the shape of a circle, an ellipse, or a polygon, for example a quadrangle.

The first orifices of the perforated first wall may have a regular pattern or varied patterns.

The bottom wall may advantageously comprise a third wall which is removably fixed to the perforated first wall and which comes to rest against the perforated first wall so as to close off the first orifices of the perforated first wall when the third wall is fixed to the perforated first wall. This feature allows easily unblocking the first orifices of the perforated first wall by detaching the third wall from the perforated first wall.

The third wall may in particular come to rest against the perforated first wall from the outside. Outside is understood to mean opposite to the inside of the removable container.

The third wall may in particular have a plate shape.

The third wall may be substantially solid. Solid is understood to mean that the third wall does not comprise orifices able to allow powder to pass through.

In particular, the perforated first wall may be inserted along the vertical axis, between a volume receiving the powder and the third wall.

The third wall may be movable relative to the perforated first wall. For example, the third wall and the perforated first wall may be slidably connected to each other, for example along an axis substantially perpendicular to the vertical axis. The third wall may be removed by sliding it against the perforated first wall, along said axis.

The third wall and the perforated first wall may be fixed to each other by means of a screw, for example a quarter-turn screw.

Advantageously, the third wall may comprise first protrusions intended to engage in the first orifices so as to close off the first orifices of the perforated first wall. In other words, the first protrusions of the third wall may fit into the first orifices of the perforated first wall. The third wall and the perforated first wall together may form a manufacturing support face oriented towards the interior of the removable container. The manufacturing support face is advantageously planar.

The bottom wall may comprise a build plate. A build plate is understood to mean a plate providing mechanical support for a block formed of powder and parts. The build plate may also perform the function of driving the bottom wall along the vertical axis during manufacturing.

The third wall may in particular comprise the build plate. In particular, the build plate may form the third wall. The build plate may then come to rest against the perforated first wall so as to close off the first orifices of the perforated first wall when the build plate is fixed to the perforated first wall. Because machines for binder jetting additive manufacturing generally comprise a build plate, this feature makes it possible to use such a build plate to provide mechanical support for the block formed of powder and parts, and to close off the first orifices of the perforated first wall.

Alternatively, the third wall may be inserted between the perforated first wall and the build plate. The third wall may in particular rest on the build plate, and in particular be removably fixed to the build plate.

The side wall may advantageously comprise a perforated second wall comprising second orifices configured to be closed off in the manufacturing configuration and unblocked in the depowdering configuration. This technical feature makes it possible to carry out the depowdering operation through the side wall of the removable container.

The perforated second wall may be perforated in the same pattern or in a different pattern than the perforated first wall.

A maximum dimension of the second orifices of the perforated second wall is preferably less than, preferably less than 50% of, a minimum dimension of the at least one part to be manufactured in the removable container.

The second orifices of the perforated second wall may have the shape of a circle, an ellipse, or a polygon, for example a quadrangle.

The second orifices of the perforated second wall may have a regular pattern or varied patterns.

The side wall may comprise a fourth wall removably fixed against the perforated second wall so as to close off the second orifices in the manufacturing configuration and unblock the second orifices in the depowdering configuration.

The fourth wall may come to rest removably against the perforated second wall from the outside.

The fourth wall may advantageously comprise second protrusions intended to engage in the second orifices so as to close off the second orifices of the perforated second wall. In particular, the fourth wall and the perforated second wall may form an internal periphery, meaning oriented towards the inside of the removable container, which is planar.

The second orifices may be arranged in a lower portion of the perforated second wall along the vertical axis. The lower portion of the perforated second wall may in particular extend from a lower end of the perforated second wall to a height that is less than 75%, preferably 50%, of the height of the side wall.

The side wall may comprise means for retaining the bottom wall. The bottom wall may thus be held by the side wall during a transfer of the removable container to the depowdering zone.

The side wall may comprise a shoulder, at a lower end of the side wall, against which the bottom wall is intended to rest. This feature allows maintaining the vertical position of the bottom wall. In particular, the perforated first wall may rest on the shoulder. The perforated first wall may thus be retained by the side wall during depowdering.

The system according to the present disclosure may advantageously comprise means for hermetically sealing an upper opening of the removable container. The means for hermetically sealing may comprise a lid intended to come to rest on an upper periphery of the removable container. The lid may, for example, be fixed to the removable container by a retaining clamp.

The bottom wall may advantageously be driven along the vertical axis by a displacement member removably mounted on the bottom wall. The displacement member may in particular consist of a piston, for example mounted on the bottom wall by means of a thread and a tapping. The piston may carry the tapping and the bottom wall the thread. Conversely, the piston may carry the thread and the bottom wall the tapping.

In the manufacturing configuration, the removable container is advantageously attached to the build chamber and/or to a frame of the additive manufacturing system, by a mechanical or magnetic retaining means, by suction cup, or by adhesive.

According to another aspect, a method for binder jetting additive manufacturing and depowdering is proposed for the system as described above. The method comprises:
inserting the removable container into the build chamber,
manufacturing at least one green part by the successive deposition of layers of powder and the spraying of binder in the removable container while moving the bottom wall downwards in translation along the vertical axis,
removing the removable container from the build chamber,
unblocking the perforated first wall.

The powder can thus flow through the perforated first wall.

Advantageously, unblocking the perforated first wall may comprise detaching the third wall from the perforated first wall.

The method according to the present disclosure may comprise an additional step of removing excess powder.

The manufacturing is carried out using a method of binder jetting additive manufacturing. Green parts manufactured using this method are fragile, due to there being no powder fusion. In this context, the method according to the present disclosure offers the considerable advantage of simplifying depowdering while reducing any possible deformation and breakage of the green parts. In addition, the method according to the present disclosure allows reducing the depowdering time and therefore the associated costs.

### BRIEF DESCRIPTION OF DRAWINGS

Other features, details and advantages will become apparent from reading the detailed description below, and from analyzing the attached drawings, in which:

FIG. 1A and FIG. 1B schematically illustrate partial section views of a conventional machine for binder jetting additive manufacturing, respectively in two manufacturing configurations.

FIG. 2A, FIG. 2B, and FIG. 2C schematically illustrate partial section views of a system for binder jetting additive manufacturing according to one embodiment, respectively in two manufacturing configurations and in a depowdering configuration.

FIG. 3 schematically illustrates an example of a perforated first wall according to one embodiment.

FIG. 4 schematically illustrates another example of a perforated first wall according to one embodiment.

FIG. 5A, FIG. 5B, and FIG. 5C schematically illustrate partial section views of a system for binder jetting additive manufacturing according to another embodiment, respectively in two manufacturing configurations and in a depowdering configuration.

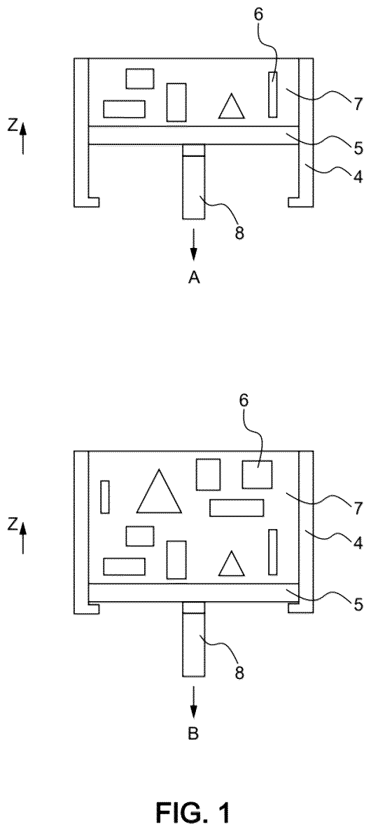

### DESCRIPTION OF EMBODIMENTS

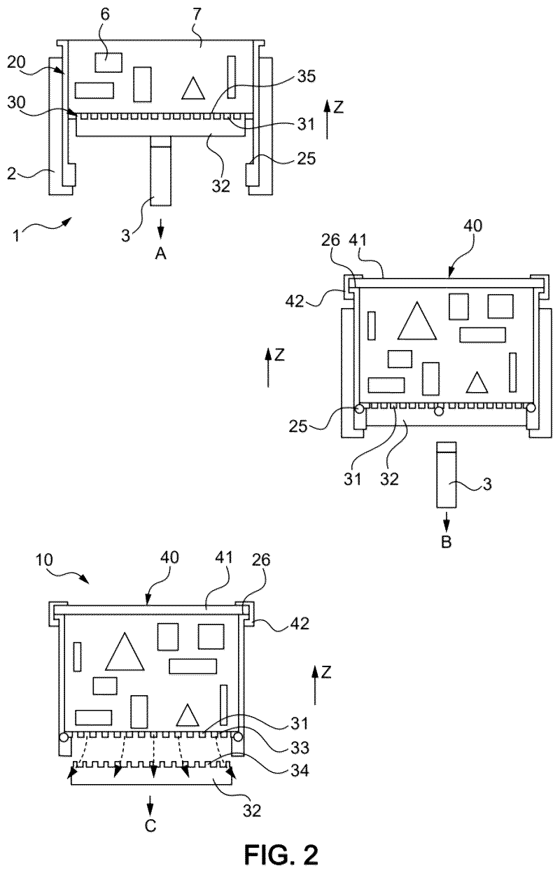

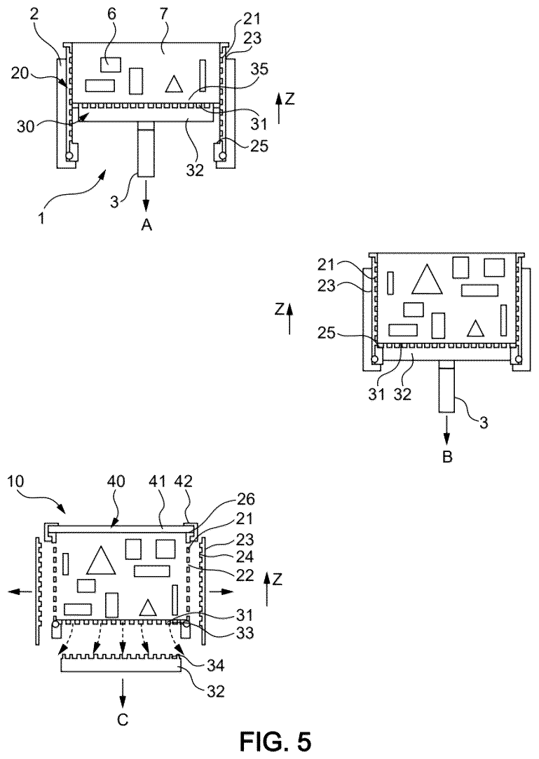

Reference is now made to FIGS. 2A, 2B, and 2C, schematically representing partial section views of a first example of an additive manufacturing system 1 according to the present document, respectively at two instants in a manufacturing configuration (FIGS. 2A and 2B) and in a depowdering configuration (FIG. 2C), and to FIGS. 5A, 5B, and 5C, schematically representing partial section views of a second example of an additive manufacturing system 1 according to the present document, respectively at two instants in the manufacturing configuration (FIGS. 5A and 5B) and in the depowdering configuration (FIG. 5C). System 1 is suitable for implementing a method for binder jetting additive manufacturing. Preferably, such a system 1 may be used to produce parts in the field of aeronautics.

The manufacturing configuration relates in particular to a phase of forming at least one part 6 in a volume of powder 7, and the depowdering configuration aims in particular to release said at least one part 6 from powder 7.

The system comprises a build chamber 2 extending along a vertical axis Z, and a removable container 10 capable of being inserted into build chamber 2 in the manufacturing configuration and of being removed from build chamber 2 in the depowdering configuration. The vertical axis Z corresponds in particular to the manufacturing direction.

The removable container 10 comprises a side wall 20 extending along vertical axis Z and a bottom wall 30 which is capable of moving along the vertical axis Z inside the side wall 20. The side wall 20 may in particular come to rest against an internal lateral surface of build chamber 2. The bottom wall 30 may advantageously be driven along the vertical axis Z by a displacement member 3 removably mounted on the bottom wall 30. The displacement member 3 may in particular consist of a piston, for example mounted on the bottom wall 30 by means of a thread and a tapping. The piston may carry the tapping and the bottom wall the thread. Conversely, the piston may carry the thread and the bottom wall the tapping.

In the manufacturing configuration, the removable container 10 may advantageously be fixed to the build chamber 2 and/or to a frame of additive manufacturing system 1, by a mechanical holding means, by suction cup, or by adhesion.

In the manufacturing configuration, the method in particular comprises successive steps of depositing a layer of powder 7 on the bottom wall 30 in the build plane and moving the bottom wall 30 downwards in translation along the vertical axis Z in order to enable the deposition of the next layer of powder. A jet of binder is selectively projected onto the powder bed prior to the deposition of the next layer, in order to form a section of the green part. Note that the build plane is substantially perpendicular to the vertical axis Z. The above steps are successively repeated, layer after layer, to form said at least one green part 6. FIGS. 2A and 2B represent in particular two successive instants in the manufacturing of parts in the first exemplary system 1. Similarly, FIGS. 5A and 5B represent in particular two successive instants in the manufacturing of green parts in the second exemplary system 1. FIGS. 2B and 5B correspond in particular to the end of the manufacturing of green parts in the build chamber 2.

In addition, the bottom wall 30 comprises a perforated first wall 31 comprising first orifices 33 configured to be closed off in the manufacturing configuration and unblocked in the depowdering configuration. “Closed off” is understood to mean that a flow of powder cannot pass through the orifices, and “unblocked” is understood to mean that a flow of powder can freely pass through the orifices.

Thus, in the manufacturing configuration, the removable container 10 is advantageously housed in the build chamber 2, and the first orifices 33 of the perforated first wall 31 are closed off (FIGS. 2A and 2B, and 5A and 5B). In the depowdering configuration, as illustrated in FIGS. 2C and 5C, the removable container 10 can be moved out of the build chamber 2, for example into a depowdering zone, and the first orifices 33 of the perforated first wall 31 can be unblocked to allow powder to flow through the first orifices 33 (the flow of powder is represented by dotted arrows in FIGS. 2C and 5C). The perforated first wall 31 in particular performs a sieve function by retaining the parts 6 and allowing the powder 7 to flow out of the removable container 10 by gravity.

Such a system makes it possible to facilitate and improve the depowdering of parts after said green parts have been produced by the successive deposition of layers of powder and binder jetting. Indeed, the removable container allows easily removing from the build chamber, and moving to a depowdering zone, a block formed of powder in which at least one green part is embedded. Such a removable container may also easily be utilized with an existing additive manufacturing machine. In the depowdering zone, unblocking the first orifices of the perforated first wall facilitates the discharge of powder through the bottom wall, while reducing the risks of deformation or even breakage of the at least one green part. The removable container also makes it possible to manufacture smaller and/or lighter parts. In addition, the removable container is advantageously compatible with depowdering techniques that involve immersion in a liquid bath, blowing air, or mechanical vibrations. In addition, the removable container according to the present disclosure allows limiting a user's exposure to the powder, for example when handling the additive manufacturing system.

The bottom wall 30 may advantageously comprise a third wall which is removably fixed to the perforated first wall 31 and which comes to rest against the perforated first wall 31 so as to close off the first orifices 33 of the perforated first wall 31 when the third wall is fixed to the perforated first wall 31. In particular, the third wall may come to rest against the perforated first wall 31 from the outside. Outside is understood to mean opposite to the inside of the removable container. This feature allows easily unblocking the first orifices 33 of the perforated first wall 31 by detaching the third wall from the perforated first wall 31.

The third wall may in particular have a plate shape.

The third wall may be substantially solid. Solid is understood to mean that the third wall does not comprise orifices able to allow powder to pass through.

In particular, the perforated first wall 31 may be inserted along the vertical axis, between a volume receiving the powder and the third wall.

The third wall may be movable relative to the perforated first wall 31. For example, the third wall and the perforated first wall 31 may be slidably connected to each other, for example along an axis substantially perpendicular to vertical axis Z. The third wall may thus be removed by sliding it against the perforated first wall 31, along said axis.

The third wall and the perforated first wall 31 may be fixed to each other by means of a screw, for example a quarter-turn screw.

Advantageously, the third wall may comprise first protrusions intended to engage in the first orifices so as to close off the first orifices 33 of the perforated first wall 31. In other words, the first protrusions of the third wall may fit into the first orifices 33 of the perforated first wall 31. The first protrusions may in particular project along the vertical axis Z.

The third wall and the perforated first wall 31 may together form a manufacturing support face 35 oriented towards the inside of the removable container 10. The manufacturing support face 35 is advantageously planar.

Preferably, the bottom wall 30 may comprise a build plate 32. The build plate 32 is understood to mean a plate providing mechanical support for a block formed of powder and parts. The build plate 32 may also perform the function of driving bottom wall 30 along the vertical axis during manufacturing.

The third wall may in particular comprise the build plate 32. In particular, the build plate 32 may form the third wall. The build plate 32 may then come to rest against the perforated first wall 31 so as to close off the first orifices 33 of the perforated first wall 31 when the build plate 32 is fixed to the perforated first wall 31. Because machines for binder jetting additive manufacturing generally comprise a build plate, this feature makes it possible to use such a build plate to provide mechanical support for the assembly formed of powder and green parts, and to close off the first orifices of the perforated first wall.

The build plate 32 may comprise first protrusions 34 intended to engage in the first orifices so as to close off the first orifices 33 of the perforated first wall 31.

Alternatively, the third wall may be inserted between the perforated first wall 31 and the build plate 32 (not shown in the figures). The third wall may in particular rest on the build plate, and in particular be removably fixed to the build plate. In this manner, the third wall can advantageously fulfill the function of closing off the first orifices of the perforated first wall, and the build plate can carry out the mechanical support function for the assembly formed of powder and said at least one green part.

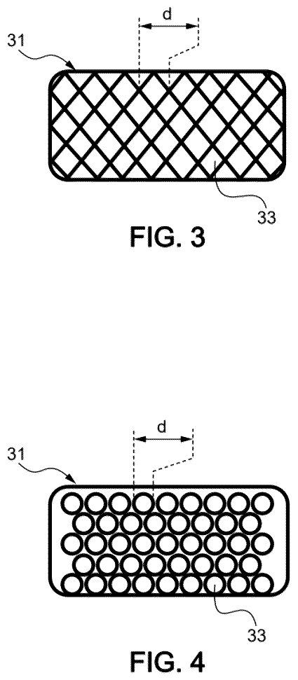

FIGS. 3 and 4 schematically illustrate the perforated first wall 31. A maximum dimension d of the first orifices 33 of the perforated first wall 31 is preferably less than, preferably less than 50% of, a minimum dimension of said at least one part to be manufactured in the removable container 10. The first orifices 33 of the perforated first wall 31 may for example have the shape of a circle, an ellipse, or a polygon, for example a quadrangle. These shapes are non-limiting. In addition, the first orifices 33 of the perforated first wall 31 may have a regular pattern or varied patterns.

With reference to FIGS. 2A, 2B, and 2C, the side wall 20 may be formed as one piece.

With reference to FIGS. 5A, 5B, and 5C, the side wall 20 may advantageously comprise a perforated second wall 21 comprising second orifices 22 configured to be closed off in the manufacturing configuration and unblocked in the depowdering configuration. This technical feature makes it possible to carry out the depowdering operation through the side wall 20 of the removable container 10, in addition to the bottom wall 30.

The side wall 20 may be formed of a plurality of perforated second walls when appropriate.

The perforated second wall 21 may be perforated in the same pattern or in a different pattern than the perforated first wall 31.

A maximum dimension of the second orifices 22 of the perforated second wall 21 is preferably less than, preferably less than 50% of, a minimum dimension of the at least one part to be manufactured in the removable container 10. The second orifices 22 of the perforated second wall 21 may have the shape of a circle, an ellipse, or a polygon, for example a quadrangle. In addition, the second orifices 22 of the perforated second wall 21 may have a regular pattern or varied patterns.

The side wall 20 may comprise a fourth wall 23 removably fixed against the perforated second wall 21 so as to close off the second orifices 22 in the manufacturing configuration and unblock the second orifices 22 in the depowdering configuration.

The fourth wall 23 may come to rest removably against the perforated second wall 21 from the outside. As a reminder, outside is understood to mean opposite to the inside of the removable container.

In addition, the fourth wall 23 may comprise second protrusions 24 intended to engage in the second orifices so as to close off the second orifices 22 of the perforated second wall 21. In particular, the fourth wall 23 and the perforated second wall 21 may form an internal periphery, meaning oriented towards the inside of the removable container, which is planar.

The fourth wall 23 may be movable relative to the perforated first wall 31. For example, the fourth wall 23 and the perforated second wall 21 may be slidably connected to each other, for example along the vertical axis Z. The fourth wall 23 may thus be removed by sliding it against the perforated second wall 21 along the vertical axis Z.

The second orifices 22 may be arranged in a lower portion of the perforated second wall 21 along the vertical axis Z. The lower portion of the perforated second wall 21 may in particular extend from a lower end of the perforated second wall 21 to a height that is less than 75%, preferably 50%, of the height of the side wall.

The side wall 20 may comprise means 25 for retaining the bottom wall 30. The bottom wall 30 may thus be held by the side wall during a transfer of the removable container to the depowdering zone.

The side wall 20 may comprise a shoulder, at a lower end of the side wall, against which the bottom wall 30 is intended to rest. This feature allows maintaining the vertical position of the bottom wall 30. In particular, the perforated first wall 31 may rest on the shoulder. The perforated first wall may thus be retained by the side wall during depowdering.

The system according to the present disclosure may advantageously comprise means 40 for hermetically sealing the upper opening of the removable container 10.

For example, the means 40 for hermetically sealing may comprise a lid 41 intended to come to rest on an upper periphery 26 of the removable container 10. The lid 41 may, for example, be fixed to the removable container 10 by means of a retaining clamp 42.

The means for hermetically sealing may in particular be put in place before the removable container is removed to the depowdering zone. Thus, during the transfer of the removable container from the build chamber to the depowdering zone, the removable container is covered. This allows limiting or even preventing the inhalation of loose powders by a user.

The means for hermetically sealing may be kept on or removed during depowdering.

According to another aspect, a method for binder jetting additive manufacturing and depowdering is proposed for system 1 as described above. The method comprises:
inserting the removable container 10 into the build chamber 2,
manufacturing at least one green part by the successive deposition of layers of powder and by binder jetting in the removable container 10 while moving the bottom wall 30 downwards in translation along the vertical axis Z,
removing the removable container 10 from the build chamber 2,
unblocking the perforated first wall 31.

The powder can thus flow through the perforated first wall 31.

Advantageously, unblocking the perforated first wall 31 may comprise detaching the third wall from the perforated first wall 31.

The method may comprise an additional step of removing excess powder after unblocking the perforated first wall 31.

The manufacturing is carried out using a method of binder jetting additive manufacturing. Parts manufactured using this method are fragile, due to there being no fusion, and are therefore susceptible to breakage. In this context, the method according to the present disclosure offers the considerable advantage of simplifying depowdering while reducing any possible deformation and breakage of the parts. In addition, the method according to the present disclosure reduces depowdering time and therefore the associated costs.

More specifically, the method for binder jetting additive manufacturing consists successively of a step of depositing a layer of powder on the bottom wall, followed by a step of selectively spraying a liquid binder through a nozzle in order to solidify a section of the part in the build plane. The bottom wall is then moved downward in translation along vertical axis Z to allow the deposition of the next layer of powder. The above steps are successively repeated, layer after layer, to form at least one part known as a green part. The green parts are then subjected to a debinding treatment in order to eliminate most of the binder. The brown part obtained after debinding is heat-treated to ensure cohesion of the parts and densification of the material, for example in a sintering process.

1. A system (1) for binder jetting additive manufacturing, comprising:
a build chamber (2) extending along a vertical axis (Z); and
a removable container (10) capable of being inserted into the build chamber (2) in a manufacturing configuration and of being removed from the build chamber (2) in a depowdering configuration, the removable container (10) comprising:
a side wall (20) extending along the vertical axis (Z); and
a bottom wall (30) which is capable of movement along the vertical axis (Z) inside the side wall (20) and which comprises a perforated first wall (31) comprising first orifices (33) configured to be closed off in the manufacturing configuration and unblocked in the depowdering configuration.

2. The system according to claim 1, wherein the bottom wall (30) comprises a build plate (32) removably fixed to the perforated first wall (31), the build plate (32) coming to rest against the perforated first wall (31) so as to close off the first orifices (33) of the perforated first wall (31) when the build plate (32) is fixed to the perforated first wall (31).

3. The system according to claim 2, wherein the build plate (32) comprises first protrusions (34) intended to engage in the first orifices so as to close off the first orifices (33) of the perforated first wall (31).

4. The system according to claim 1, wherein the side wall (20) comprises a perforated second wall (21) comprising second orifices (22) configured to be closed off in the manufacturing configuration and unblocked in the depowdering configuration.

5. The system according to claim 4, wherein the side wall (20) comprises a fourth wall (23) removably fixed against the perforated second wall (21) so as to close off the second orifices (22) in the manufacturing configuration and unblock the second orifices (22) in the depowdering configuration.

6. The system according to claim 5, wherein the fourth wall (23) comes to rest removably against the perforated second wall (21) from the outside and comprises second protrusions intended to engage in the second orifices so as to close off the second orifices (22) of the perforated second wall (21).

7. The system according to claim 4, wherein the second orifices (22) are arranged in a lower portion of the perforated second wall (21) along the vertical axis (Z).

8. The system according to claim 1, wherein the side wall (20) may comprise means (25) for retaining the bottom wall (30).

9. The system according to claim 1, wherein a maximum dimension (d) of the first orifices (33) is less than approximately 50% of a minimum dimension of a part to be manufactured in the removable container (10).

10. The system according to claim 1, comprising means (40) for hermetically sealing an upper opening of the removable container (10).

11. The system according to claim 1, wherein the bottom wall (30) is driven along the vertical axis (Z) by a displacement member (3) removably mounted on the bottom wall (30).

12. Method for binder jetting additive manufacturing and depowdering, for the system (1) according to claim 1, the method comprising:
inserting the removable container (10) into the build chamber (2),
manufacturing at least one part by the successive deposition of layers of powder in the removable container (10) and the selective spraying of binder while moving the bottom wall (30) downwards in translation along the vertical axis (Z),
removing the removable container (10) from the build chamber (2),
unblocking the perforated first wall (31).
